(19) United States
(12) Patent Application Publication
(10) Pub. No.: US 2016/0188271 A1
(43) Pub. Date: Jun. 30, 2016

(54) INFORMATION PROCESSING APPARATUS, NON-TRANSITORY COMPUTER READABLE MEDIUM, AND INFORMATION PROCESSING METHOD

(71) Applicant: FUJI XEROX CO., LTD., Tokyo (JP)

(72) Inventors: Hirotaka SASAKI, Kanagawa (JP); Masayoshi MIKI, Kanagawa (JP); Akio OKUIE, Kanagawa (JP)

(73) Assignee: FUJI XEROX CO., LTD., Tokyo (JP)

(21) Appl. No.: 14/749,149

(22) Filed: Jun. 24, 2015

(30) Foreign Application Priority Data
Dec. 25, 2014 (JP) 2014-261786

(51) Int. Cl. G06F 3/12; H04N 1/44; H04N 1/00; G06K 9/00

(52) U.S. Cl. CPC G06F 3/1222; G06K 9/00228; G06F 3/1238; G06F 3/1288; H04N 1/4413; H04N 1/4426; H04N 1/442; H04N 1/00251; H04N 1/00795

(57) ABSTRACT

An image processing apparatus includes an acquiring unit that acquires face information, the face information indicating a face of a user captured by an image capturing unit, a memory that stores an identifier of a user permitted to log in to the information processing apparatus, in association with first face information indicating a face of the user, a writing unit that, if a predetermined condition is satisfied during a period from login to logout of a user on the information processing apparatus, writes the face information acquired by the acquiring unit into the memory as second face information in association with an identifier of the user, and a restricting unit that, if the second face information satisfies a predetermined condition with respect to the face information acquired by the acquiring unit, restricts login as the user of the identifier associated with the first face information.

### CROSS-REFERENCE TO RELATED APPLICATIONS

This application is based on and claims priority under 35 USC 119 from Japanese Patent Application No. 2014-261786 filed Dec. 25, 2014.

### BACKGROUND

### Technical Field

The present invention relates to an information processing apparatus, a non-transitory computer readable medium, and an information processing method.

### SUMMARY

According to an aspect of the invention, there is provided an image processing apparatus including an acquiring unit that acquires face information, the face information indicating a face of a user captured by an image capturing unit, a memory that stores an identifier of a user permitted to log in to the information processing apparatus, in association with first face information indicating a face of the user, a writing unit that, if a predetermined condition is satisfied during a period from login to logout of a user on the information processing apparatus, writes the face information acquired by the acquiring unit into the memory as second face information in association with an identifier of the user, and a restricting unit that, if the second face information satisfies a predetermined condition with respect to the face information acquired by the acquiring unit, restricts login as the user of the identifier associated with the first face information.

### BRIEF DESCRIPTION OF THE DRAWINGS

Exemplary embodiment of the present invention will be described in detail based on the following figures, wherein:

FIG. 1 illustrates the outward appearance of an image forming apparatus according to an exemplary embodiment of the present invention;

FIG. 2 illustrates a hardware configuration of the image forming apparatus;

FIG. 3 illustrates an example of an authentication table TB1;

FIG. 4 is a block diagram illustrating a functional configuration of the image forming apparatus;

FIG. 5 is a flowchart of an authentication process;

FIG. 6 is a flowchart of the process after logout;

FIG. 7 illustrates an example of a screen displayed on a display; and

FIG. 8 illustrates an example of a screen displayed on a display.

### DETAILED DESCRIPTION

### Exemplary Embodiment

### Configuration of Exemplary Embodiment

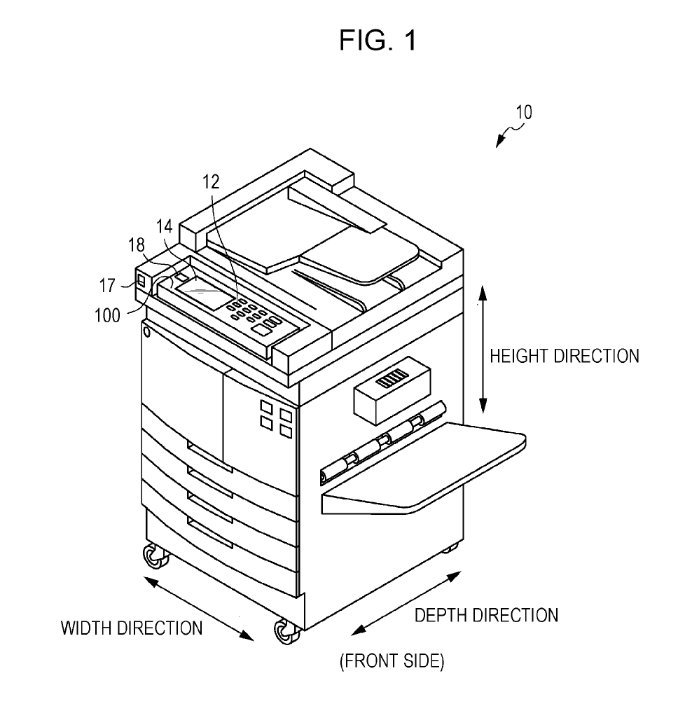

Hereinafter, an information processing apparatus according to an exemplary embodiment of the invention as applied to an image forming apparatus will be described. FIG. 1 is a perspective view illustrating the outward appearance of an image forming apparatus 10 according to an exemplary embodiment of the invention. A user who uses the image forming apparatus 10 stands in front of the image forming apparatus 10, and operates an operation panel unit 100. The operation panel unit 100 is located at the front side of the top surface of the image forming apparatus 10. In this example, the operation panel unit 100 includes an operating unit 12, a display 14, and an image capturing unit 18. The image forming apparatus 10 performs various information processing in accordance with an operation made on the operating unit 12, such as scanning that generates an image of a document that has been read, copying that makes a copy of a document, and facsimile communication that transmits/receives an image of a document via a communication line. Use of the image forming apparatus 10 is permitted for users determined in advance by an administrator who manages the image forming apparatus 10. The image forming apparatus 10 executes a process of authenticating if a user is a person allowed to use the image forming apparatus 10.

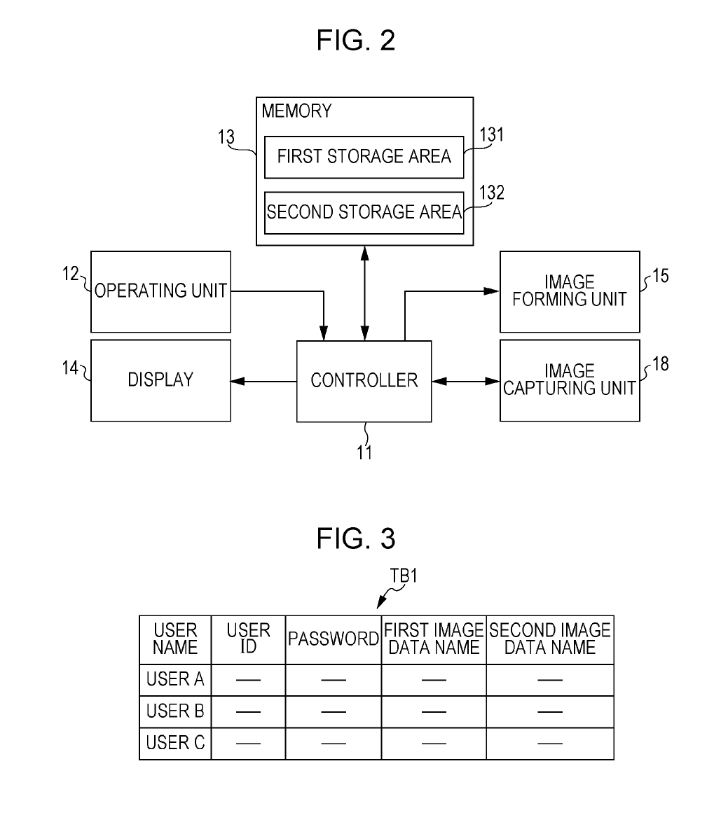

FIG. 2 is a block diagram illustrating a hardware configuration of the image forming apparatus 10. As illustrated in FIG. 2, the image forming apparatus 10 includes a controller 11, the operating unit 12, a memory 13, the display 14, an image forming unit 15, and the image capturing unit 18.

The controller 11 includes a central processing unit (CPU), a read only memory (ROM), and a random access memory (RAM). The CPU controls various units of the image forming apparatus 10 by executing control programs stored in the ROM and the memory 13.

The image capturing unit 18 is located adjacent to the display 14 in the width direction of the image forming apparatus 10. The image capturing unit 18 has an image capturing lens and an imaging device. The image capturing unit 18 captures the face of a user to generate image data of the captured face. The image capturing unit 18 may not necessarily be located adjacent to the display 14 but may be located elsewhere as long as the image capturing unit 18 is able to capture the face of a user.

The operating unit 12 is an operating device including multiple operators. The operating unit 12 receives an operation made by a user, and supplies an operation signal indicating the received operation to the controller 11.

The memory 13 has, for example, a hard disk device. The memory 13 stores a control program executed by the controller 11, and image data of faces. The memory 13 has a first storage area 131 and a second storage area 132 as storage areas for storing image data of faces. In the first storage area 131, image data of the face of each user permitted to use the image forming apparatus 10 is stored as first image data. In the second storage area 132, among image data used when a user is erroneously authenticated, image data generated by the image capturing unit 18 is stored as second image data. The memory 13 is an example of a memory that stores face information indicating the face of a user. The first image data is an example of first face information indicating the face of a user. The second image data is an example of second face information generated by the image capturing unit 18 and written into the memory 13.

The memory 13 stores an authentication table TB1. Information for authenticating a person who is permitted to use the image forming apparatus 10 by the administrator is stored in the authentication table TB1. FIG. 3 illustrates an example of the authentication table TB1. In the authentication table TB1, one record is provided for each person permitted to use the image forming apparatus 10. A User Name field stores the name of a person permitted to use the image forming apparatus 10. A User ID field stores an identifier assigned to a person permitted to use the image forming apparatus 10. A Password field stores a password for verifying a person permitted to use the image forming apparatus 10. A First Image Data Name field stores the file name of first image data indicating the face of a user. A Second Image Data Name field stores the file name of second image data stored in the second storage area 132.

The display 14 includes, for example, a liquid crystal display. The display 14 is located adjacent to the operating unit 12 in the width direction of the image forming apparatus 10. The display 14 is a display device that displays an image (screen) on its display surface. The image forming unit 15, which is controlled by the controller 11, forms an image on a sheet of paper or the like by the electrophotographic process. In addition to the components mentioned above, the image forming apparatus 10 also has components such as an image reading unit that reads an image of a document or the like, and a communication unit for communicating with an external apparatus via a communication line.

An example of information processing executed by the image forming apparatus 10 will be descried below. When copying is to be executed, the controller 11 causes the image reading unit to read an image of a document to generate image data of the document, and an image is formed on a sheet by the image forming unit 15 based on this image data. When scanning is to be executed, the controller 11 causes the image reading unit to read an image of a document to generate image data, and this image data is either stored into the memory 13 or transmitted to an external apparatus via a communication line. When facsimile communication is to be executed, at the time of transmitting data, the controller 11 causes the image reading unit to read an image of a document to generate image data, and this image data is transmitted via a telephone line (not illustrated), and at the time of receiving data, image data is received via a telephone line (not illustrated), and an image is formed on a sheet by the image forming unit 15 based on the received image data.

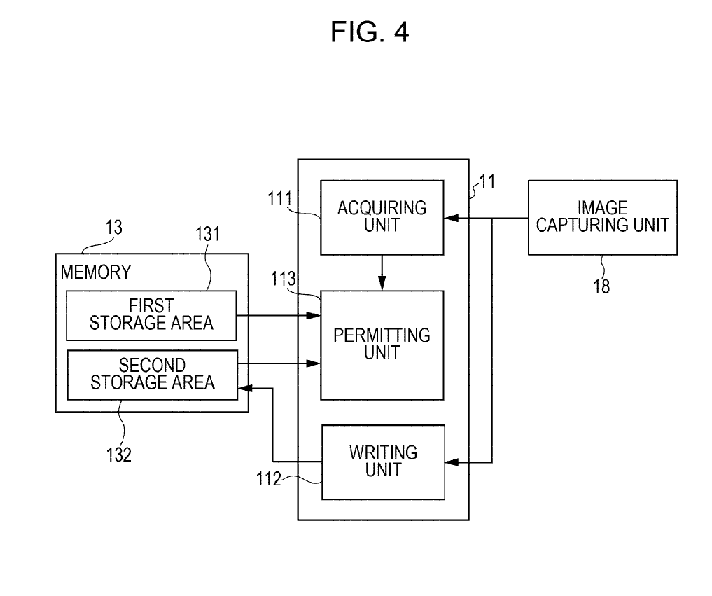

FIG. 4 is a block diagram illustrating a functional configuration of the controller 11 of the image forming apparatus 10. As illustrated in FIG. 4, the controller 11 has an acquiring unit 111, a writing unit 112, and a permitting unit 113.

The acquiring unit 111 acquires image data of the face of a user from the image capturing unit 18. The image data acquired at this time is an example of face information indicating the face of a user.

The writing unit 112 is an example of a writing unit that, if a predetermined condition is satisfied during the period from when a user is permitted to use the image forming apparatus 10 to when the user finishes use of the image forming apparatus 10, writes image data generated by the image capturing unit 18 into the second storage area 132 of the memory 13 as second image data in association with the user name of the user.

The permitting unit 113 is an example of a permitting unit that permits a user to use the image forming apparatus 10. The permitting unit 113 permits a user to use the image forming apparatus 10 if first image data stored in the first storage area 131 satisfies a predetermined condition with respect to image data acquired by the acquiring unit 111. Specifically, the permitting unit 113 permits use of the image forming apparatus 10 to a user with a user name associated with first image data if the following predetermined condition is satisfied: the difference between features of a face acquired from image data acquired by the acquiring unit 111, and features of a face acquired from first image data is less than a threshold. The permitting unit 113 restricts use of the image forming apparatus 10 for a user with a user name associated with second image data if the following predetermined condition is satisfied: the difference between features of a face acquired from image data acquired by the acquiring unit 111 and features of a face acquired from second image data stored in the second storage area 132 is less than a threshold. That is, the permitting unit 113 is an example of a restricting unit that restricts use of the image forming apparatus 10 for a user.

(Operation Example of Exemplary Embodiment)

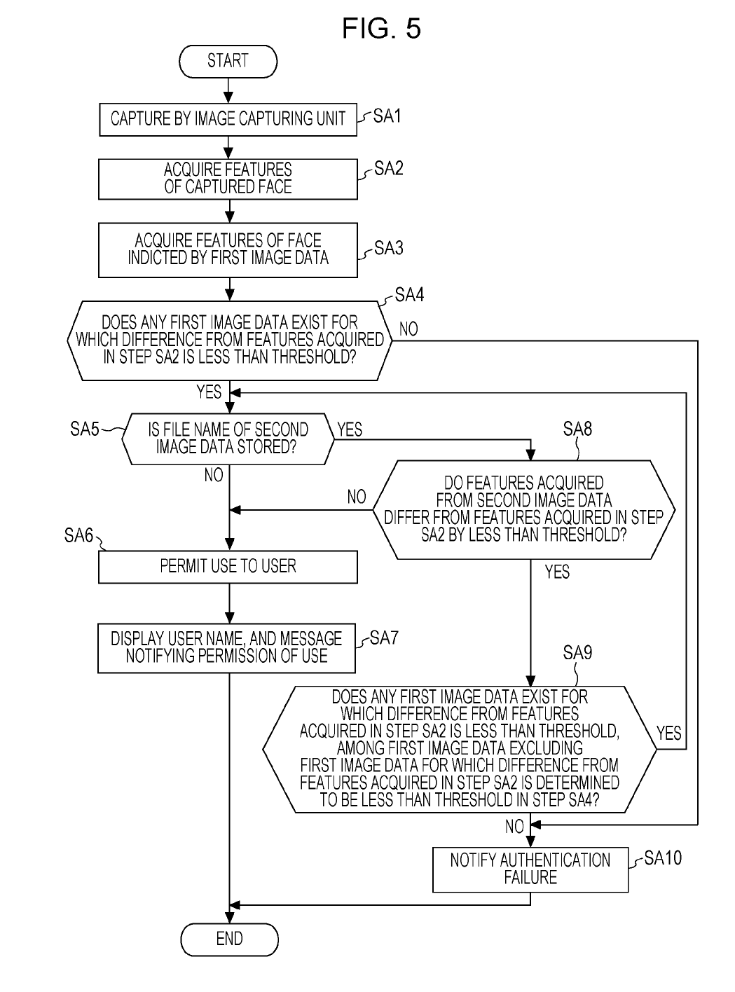

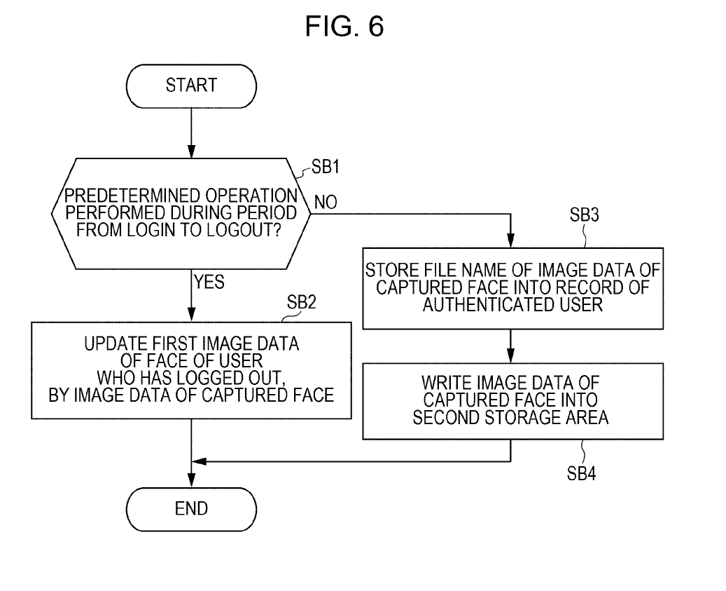

FIGS. 5 and 6 are flowcharts illustrating processing performed by the image forming apparatus 10. An example of operation when the image forming apparatus 10 performs face authentication of a user will be described below with reference to FIGS. 5 and 6.

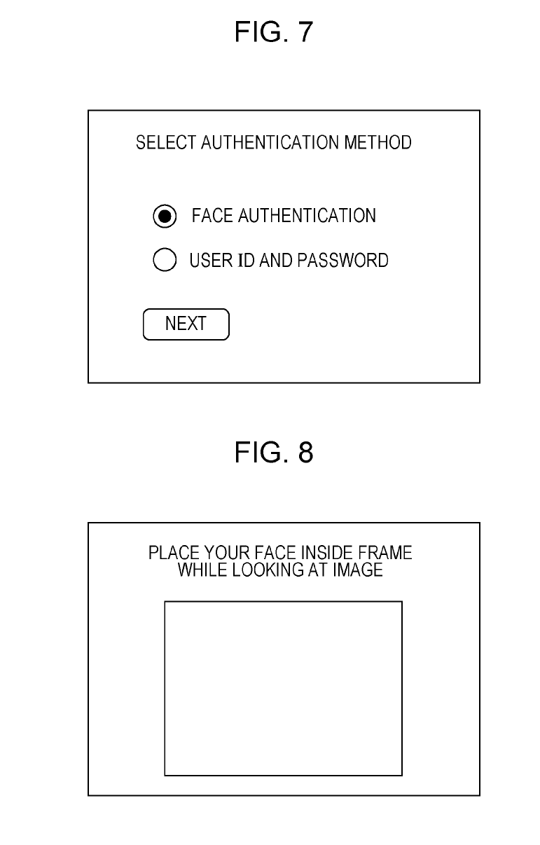

First, an example of operation when a user is correctly authenticated will be described. The controller 11 controls the display 14 so that when a user is not logged in, the display 14 displays a screen (FIG. 7) for prompting the user to select one of an authentication method using a face image and an authentication method using a user ID and a password. For example, once a user C performs an operation to select face authentication as an authentication method on the screen illustrated in FIG. 7, the controller 11 controls the image capturing unit 18 and the display 14 so that an image captured by the image capturing unit 18 is displayed on the display 14 (step SA1). FIG. 8 illustrates an example of a screen displayed on the display 14 after the user selects face authentication as an authentication method. While looking at the display 14, the user C moves his or her body so that the face is shown inside the frame.

The controller 11 analyzes image data generated by the image capturing unit 18, and acquires features of the captured face (step SA2). Next, the controller 11 acquires first image data stored in the first storage area 131, that is, image data of the face of each user permitted to use the image forming apparatus 10, and acquires features of the face indicated by the first image data (step SA3). The controller 11 compares the features acquired in step SA2 with the features acquired in step SA3, and determines if there is any first image data for which the difference from the features acquired in step SA2 is less than a threshold (step SA4).

If there is any first image data whose features differ from the features acquired in step SA2 by less than the threshold (YES in step SA4), the controller 11 looks up a record in the authentication table TB1 which stores the file name of the first image data for which the difference in features is less than the threshold, and determines if the record stores a file name of second image data (step SA5). If the record being looked up does not store a file name of second image data (NO in step SA5), that is, if a person different from the user C has not been authenticated as the user C in the past, the controller 11 permits use of the image forming apparatus 10 to the user C (step SA6). As a result, the user C becomes logged in to the image forming apparatus 10.

Further, the controller 11 acquires, from the authentication table TB1, a user name associated with the file name of the first image data for which the difference in acquired features is less than the threshold, and controls the display 14 so as to display the acquired user name, “User C”, and a message notifying that use of the image forming apparatus 10 is now permitted (step SA7).

The user C checks the displayed user name to confirm if the user C himself or herself has been authenticated. Upon confirming that the user C himself or herself has been authenticated, the user C operates the operating unit 12 to use the image forming apparatus 10. The image forming apparatus 10 records a log of processing executed in accordance with user operation. To finish use of the image forming apparatus 10, the user C performs a logout operation with the operating unit 12.

Once the user C performs a logout operation, the controller 11 looks up the recorded log, and determines if a predetermined operation has been performed during the period from login to logout of the user C. In the exemplary embodiment, a predetermined operation is defined as an operation other than a logout operation. A predetermined operation may be a specific operation, such as an operation to command execution of copying, an operation to command execution of scanning, and an operation to command execution of facsimile communication.

If a predetermined operation has been performed during the period from login to logout of the user C (YES in step SB1), the controller 11 updates, among first image data stored in the first storage area 131, the first image data indicating the face of the user C by image data generated by the image capturing unit 18 (step SB2). Specifically, the controller 11 writes image data of the face of the user C generated by the image capturing unit 18 into the first storage area 131. Further, in the authentication table TB1, the controller 11 stores the file name of the image data written into the first storage area 131, into the First Image Data Name field of the record of the user C who has logged out. Further, the controller 11 deletes, from the first storage area 131, the first image data with the file name that is previously written in the First Image Data Name field before the First Image Data Name field is updated.

As described above, when a user is correctly authenticated, image data of the face used for authenticating the user is updated by image data of the face captured at the time of authentication.

Next, an example of operation when a user is not correctly authenticated will be described. For example, when a user B selects face authentication as an authentication method, the processes from step SA1 to step SA4 are performed in the same manner as when the user C is authenticated. Now, suppose that, for example, even though the face of the user B has been captured, the difference between features of the face indicated by the first image data of the user A, and features of the captured face of the user B is less than a threshold. In this case, the result of determination in step SA4 becomes YES. When the result of determination becomes YES in step SA4, the controller 11 looks up a record in the authentication table TB1 which stores the file name of the first image data for which the difference in features is less than the threshold, that is, the record of the user A in this example, and determines if the record stores a file name of second image data (step SA5).

If the record being looked up does not store a file name of second image data (NO in step SA5), that is, if a person different from the user A has not been authenticated as the user A in the past, the controller 11 permits use of the image forming apparatus 10 (step SA6). This results in a state in which the user A is logged in to the image forming apparatus 10, even though the person operating the image forming apparatus 10 is the user B.

Next, the controller 11 acquires, from the authentication table TB1, a user name associated with the file name of the first image data for which the difference in acquired features is less than the threshold, that is, the user name of the user A in this example, and controls the display 14 so as to display the acquired user name, and a message notifying that use of the image forming apparatus 10 is now permitted (step SA7).

The user B, having seen the display 14 and realized that the displayed user name is not his/her own user name, performs a logout operation with the operating unit 12, without using various functions of the image forming apparatus 10. Once the user performs a logout operation, the controller 11 looks up the recorded log, and determines if the user has performed a predetermined operation during the period from login to logout.

If the user has not performed a predetermined operation during the period from login to logout (NO in step SB1), the controller 11 stores the file name of image data generated by the image capturing unit 18 into the Second Image Data Name field of the record of the user A in the authentication table TB1 (step SB3), and writes the image data generated by the image capturing unit 18 into the second storage area 132 as second image data (step SB4).

Next, an example of operation when the user B erroneously authenticated as the user A as mentioned above attempts to log in again will be described. When the user B selects face authentication as an authentication method, the processes from step SA1 to step SA4 are performed. Now, suppose that, even though the face of the user B has been captured, the difference between the features of the face indicated by the first image data of the user A, and the features of the captured face of the user B is determined to be less than the threshold again. In this case, the result of determination in step SA4 becomes YES.

When the result of determination becomes YES in step SA4, the controller 11 looks up a record in the authentication table TB1 which stores the file name of the first image data for which the difference in features is less than the threshold, that is, the record of the user A in this example, and determines if the record stores a file name of second image data (step SA5). At this point, the record of the user A stores the file name of the second image data written into the second storage area 132 through the above-mentioned operation (the image data of the face of the user B captured in the operation example mentioned above) (YES in step SA5). Accordingly, the controller 11 transfers the process flow to step SA8.

In step SA8, the controller 11 acquires the second image data whose file name is stored in the Second Image Data Name field of the record of the user A in the authentication table TB1, that is, the image data of the face of the user B written into the second storage area 132 through the above-mentioned operation, and determines if the difference between features of the face included in the acquired second image data, and the features of the face of the user B captured by the image capturing unit 18 is less than the threshold.

If the difference between the features of the two faces is less than the threshold (YES in step SA8), the controller 11 determines if there is any first image data for which the difference from the features of the face of the user B acquired in step SA2 is less than the threshold, among first image data excluding the first image data of the user A for which the difference from the features of the face of the user B acquired in step SA2 is determined to be less than the threshold in step SA4 (step SA9).

At this time, if the first image data of the user B exists among the first image data excluding the first image data of the user A, and features of the face indicated by the first image data of the user B differ from the features acquired in step SA2 by less than the threshold, the controller 11 transfers the process flow to step SA5. The controller 11 looks up a record in the authentication table TB1 which stores the file name of the first image data of the user B, and determines if the record stores a file name of second image data (step SA5). If the record being looked up does not store a file name of second image data (NO in step SA5), the controller 11 permits use of the image forming apparatus 10 to the user B (step SA6). This results in a state in which the user B becomes logged in to the image forming apparatus 10.

Further, the controller 11 acquires, from the authentication table TB1, a user name associated with the file name of the first image data for which the difference in acquired features from the features acquired in step SA2 is less than the threshold, and controls the display 14 so as to display the acquired user name, “User B”, and a message notifying that use of the image forming apparatus 10 is now permitted (step SA7).

The user B checks the displayed user name to confirm if the user B himself or herself has been authenticated. Upon confirming that the user B himself or herself has been authenticated, the user B operates the operating unit 12 to use the image forming apparatus 10. The image forming apparatus 10 records a log of processing executed in accordance with user operation. To finish use of the image forming apparatus 10, the user B performs a logout operation with the operating unit 12.

Once the user B performs a logout operation, the controller 11 looks up the recorded log, and determines if a predetermined operation has been performed during the period from login to logout of the user B. If a predetermined operation has been performed during the period from login to logout of the user B (YES in step SB1), the controller 11 updates the first image data of the face of the user B stored in the first storage area 131, by the image data generated by the image capturing unit 18 (step SB2). Specifically, the controller 11 writes the image data of the face captured by the image capturing unit 18 into the first storage area 131. Further, in the authentication table TB1, the controller 11 stores the file name of the image data written into the first storage area 131, into the First Image Data Name field of the record of the user B who has logged out. Further, the controller 11 deletes, from the first storage area 131, image data of the file name that is previously written in the record of the user B before the First Image Data Name field is updated.

The controller 11 controls the display 14 so that if the result of determination in step SA4 or SA9 is NO, a message indicating authentication failure is displayed (step SA10). If the result of determination in step SA8 is NO, the controller 11 transfers the process flow to step SA6.

As described above, according to the exemplary embodiment, if a user who has attempted to log in is erroneously authenticated as another user, image data of the face captured at the time of this erroneous authentication is stored. The stored image data is used so that the next time the erroneously authenticated user attempts to log in, this user is not authenticated as another user.

Modifications

While the exemplary embodiment of the invention has been described above, the exemplary embodiment is not limited to the above exemplary embodiment but may be implemented in various manners. For example, the above exemplary embodiment may be modified and implemented as follows. The above exemplary embodiment and each of the modifications described below may be combined.

In the above exemplary embodiment, image data of faces used for authenticating a user is stored in the memory 13. However, the exemplary embodiment is not limited to this configuration. For example, an alternative configuration may be employed in which a server apparatus storing the authentication table TB1 and image data of faces is connected to the image forming apparatus 10 via a communication line, and image data generated by the image capturing unit 18 is transmitted to the server apparatus so that the server apparatus performs an authentication process. Further, the server apparatus may, upon authenticating the user, control the image forming apparatus 10 so that the user is allowed to use the image forming apparatus 10. In the case of this configuration, log data may be stored in the image forming apparatus 10, or may be stored in the server apparatus.

In the above exemplary embodiment, first image data is stored in the first storage area 131, and second image data is stored in the second storage area 132. However, the exemplary embodiment is not limited to this configuration. For example, instead of first image data, feature data indicating features of the face of each user permitted to use the image forming apparatus 10 may be stored in the first storage area 131, and instead of second image data, feature data indicating features of a face captured by the image capturing unit 18 may be stored in the second storage area 132. According to this configuration, a user is authenticated by comparing the features of the face captured by the image capturing unit 18, with the features indicated by the feature data stored in the memory 13.

The information processing apparatus according to the exemplary embodiment of the invention may not necessarily be an image forming apparatus having multiple functions. For example, the information processing apparatus may be implemented as an information processing apparatus such as a scanning apparatus, a copying machine, or a facsimile apparatus, or may be implemented as an information processing apparatus such as a personal computer or a server apparatus. Various functions implemented by the controller 11 of the image forming apparatus 10 according to the above exemplary embodiment or its modifications may be implemented by at least one hardware circuit, may be implemented by execution of at least one program by an arithmetic unit, or may be implemented by a combination of both. If the functions of the controller 11 are implemented by using at least one program, this program may be provided while being stored in a computer readable recording medium such as a magnetic recording medium (such as a magnetic tape or a magnetic disk (hard disk drive (HDD) or a flexible disk (FD)), an optical recording medium (such as an optical disc), a magneto-optical recording medium, or a semiconductor memory, or may be distributed via a communication line.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an acquiring unit that acquires face information, the face information indicating a face of a user captured by an image capturing unit;
a memory that stores an identifier of a user permitted to log in to the information processing apparatus, in association with first face information indicating a face of the user;
a writing unit that, if a predetermined condition is satisfied during a period from login to logout of a user on the information processing apparatus, writes the face information acquired by the acquiring unit into the memory as second face information in association with an identifier of the user; and
a restricting unit that, if the second face information satisfies a predetermined condition with respect to the face information acquired by the acquiring unit, restricts login as the user of the identifier associated with the first face information.

2. The information processing apparatus according to claim 1,
wherein if the first face information that is not associated with the second face information satisfies a predetermined condition with respect to the face information acquired by the image capturing unit, the restricting unit does not restrict login for the user of the identifier associated with the first face information.

3. A non-transitory computer readable medium storing a program causing a computer to execute a process for processing information, the process comprising:
acquiring face information, the face information indicating a face of a user captured by an image capturing unit;
storing an identifier of a user permitted to log in to an information processing apparatus, in association with first face information indicating a face of the user;
writing, if a predetermined condition is satisfied during a period from login to logout of a user on the information processing apparatus, the acquired face information into a memory as second face information in association with an identifier of the user; and
restricting, if the second face information satisfies a predetermined condition with respect to the acquired face information, login as the user of the identifier associated with the first face information.

4. An information processing method comprising:
acquiring face information, the face information indicating a face of a user captured by an image capturing unit;
storing an identifier of a user permitted to log in to an information processing apparatus, in association with first face information indicating a face of the user;
writing, if a predetermined condition is satisfied during a period from login to logout of a user on the information processing apparatus, the acquired face information into a memory as second face information in association with an identifier of the user; and
restricting, if the second face information satisfies a predetermined condition with respect to the acquired face information, login as the user of the identifier associated with the first face information.
